(19) United States
(12) Patent Application Publication
(10) Pub. No.: US 2015/0041342 A1
(43) Pub. Date: Feb. 12, 2015

(54) PROTECTIVE CASES FOR PORTABLE ELECTRONIC DEVICES

(71) Applicant: Jonathan D. Douros, SR., Fuquay-Varina, NC (US)

(72) Inventor: Jonathan D. Douros, SR., Fuquay-Varina, NC (US)

(21) Appl. No.: 14/454,155

(22) Filed: Aug. 7, 2014

Related U.S. Application Data
(60) Provisional application No. 61/863,091, filed on Aug. 7, 2013.

(51) Int. Cl. A45C 11/00; G06F 1/16

(52) U.S. Cl. CPC A45C 11/00; G06F 1/1613; A45C 2011/003
USPC 206/45.2; 206/320

(57) ABSTRACT

A case for use with a portable electronic device includes: an inflatable base; a sleeve on the base, with at least a portion of the sleeve being translucent to permit a user to view the portable electronic device therethrough; and a closure mechanism on the sleeve for sealably enclosing an electronic device in the sleeve. When inflated, the base has opposing upper and lower surfaces with the sleeve on the upper surface, and the upper surface is at a tilt angle with respect to the lower surface.

### RELATED APPLICATION

This application claims priority from U.S. Provisional Application No. 61/863,091, filed Aug. 7, 2013, the disclosure of which is hereby incorporated herein in its entirety.

### BACKGROUND

Portable electronic devices, such as tablet computers, are often taken to the beach or a swimming pool. However, water, sand and other debris can damage the device.

### SUMMARY

Some embodiments of the present invention are directed to a case for use with a portable electronic device. The case includes: an inflatable base; a sleeve on the base, with at least a portion of the sleeve being translucent to permit a user to view the portable electronic device therethrough; and a closure mechanism on the sleeve for sealably enclosing an electronic device in the sleeve. When inflated, the base has opposing upper and lower surfaces with the sleeve on the upper surface, and the upper surface is at a tilt angle with respect to the lower surface.

When inflated, the bottom surface of the base may include two contoured surfaces extending along a length of the bottom surface, with the two contoured surfaces adapted to receive legs of a user.

In some embodiments, the sleeve includes an upper layer that allows light to pass therethrough. The upper layer of the sleeve may be formed of an anti-reflective material. An anti-reflective coating or layer may be applied to the upper layer of the sleeve.

The case may include a valve on the base for selectively inflating and deflating the base. When inflated, the base may have sufficient buoyancy to float on water when an electronic device up to five pounds is sealably enclosed in the sleeve.

Some other embodiments of the present invention are directed to a case for use with a portable electronic device. The case includes: an inflatable member; a sleeve on the inflatable member, wherein the sleeve has an opening to receive the portable device in the sleeve, and wherein the sleeve has a translucent anti-reflective upper surface to permit a user to view the portable electronic device therethrough; and a valve assembly for selectively inflating and deflating the inflatable member. When inflated, the inflatable member has sufficient buoyancy to float on water when an electronic device at least about five pounds is sealably enclosed in the sleeve.

In some embodiments, the inflatable member includes first, second and third inflatable panels with the second inflatable panel disposed between the first and third inflatable panels. The case may be foldable to a folded position in which a transverse end of the first panel that is spaced apart from the second panel is connected to a transverse end of the third panel that is spaced apart from the second panel. The transverse end of the first panel and/or the transverse end of the third panel may include a locking mechanism configured to secure the case in the folded position. The case may have a generally triangular profile in the folded position.

In some embodiments, the third panel includes the sleeve, with the third panel further including an inflatable pocket surrounding the sleeve. A side of the inflatable pocket may include first and second inflatable portions stacked on one another with the sleeve opening defined between the first and second inflatable portions, and with the opening substantially closed when the first and second inflatable portions are inflated.

The sleeve may include first and second translucent anti-reflective opposing surfaces to permit a user to view the portable electronic device through either the first or the second translucent anti-reflective surface.

In some embodiments, the case includes a flap having a first end is connected to the side of the inflatable pocket adjacent the opening and a second end that extends away from the third panel. The side of the inflatable pocket and/or the second end of the flap may include a locking mechanism configured to secure the second end of the flap to the side of the inflatable pocket such that the flap covers the sleeve opening.

In some embodiments, the first panel includes a plurality of inflatable pockets defining two spaced-apart contoured channels extending along a length of the first panel, each channel configured to receive a respective leg of a user when the case is in the folded position.

Some other embodiments of the present invention are directed to a case for use with a portable electronic device. The case includes first, second and third longitudinally connected inflatable panels. The second panel is disposed between the first and third panels.

The first panel has a transverse end that is spaced apart from the second panel and the third panel has a transverse end that is spaced apart from the second panel. The case includes a sleeve on the third inflatable panel. The sleeve has an opening to receive the portable device in the sleeve, and the sleeve has a translucent anti-reflective upper surface to permit a user to view the portable electronic device therethrough. The case is foldable to a folded position in which the transverse end of the first panel is connected to the transverse end of the third panel. At least one of the transverse end of the first panel and the transverse end of the third panel comprises a locking mechanism to secure the case in the folded position.

In some embodiments, the third panel further includes an inflatable pocket surrounding the sleeve. A side of the inflatable pocket may include first and second inflatable portions stacked on one another with the sleeve opening defined between the first and second inflatable portions, and with the opening substantially closed when the first and second inflatable portions are inflated. The sleeve may include first and second translucent anti-reflective opposing surfaces to permit a user to view the portable electronic device through either the first or the second translucent anti-reflective surface. The case may include a flap having a first end connected to the side of the inflatable pocket adjacent the opening and a second end that extends away from the third panel. The side of the inflatable pocket and/or the second end of the flap may include a locking mechanism configured to secure the second end of the flap to the side of the inflatable pocket such that the flap covers the sleeve opening.

In some embodiments, the first panel includes three inflatable pockets defining two spaced-apart contoured channels extending along a length of the first panel, with each channel configured to receive a respective leg of a user when the case is in the folded position.

### BRIEF DESCRIPTION OF THE DRAWINGS

FIG. 1 is a perspective view of a protective case in an inflated state according to some embodiments of the present invention.

FIG. 2 is a side view of the case of FIG. 1.

FIG. 3 is a rear view of the case of FIG. 1.

FIG. 4A is a side view of a sleeve of the case of FIG. 1 with the sleeve in a closed configuration.

FIG. 4B is a side view of the sleeve of FIG. 4A in an open configuration.

FIG. 5 is a perspective view of an alternative sleeve that may be used with the case of FIG. 1 according to some embodiments of the present invention.

FIG. 6 is a perspective view of the case of FIG. 1 in a deflated state.

FIG. 7 is a cross-sectional view of the case of FIG. 1.

FIG. 8 illustrates the case of FIG. 1 with channels received by legs of a user.

FIG. 9 is a plan view of a protective case according to some other embodiments of the present invention.

FIG. 10 is a perspective view of the case of FIG. 9 with a device being inserted into a sleeve of the case.

FIG. 11 is a perspective view of the case of FIG. 9 with the device held in the sleeve of the case.

FIG. 12 is a cross-sectional view of the case of FIG. 9.

FIG. 13 is a plan view of a protective case according to some other embodiments of the present invention.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

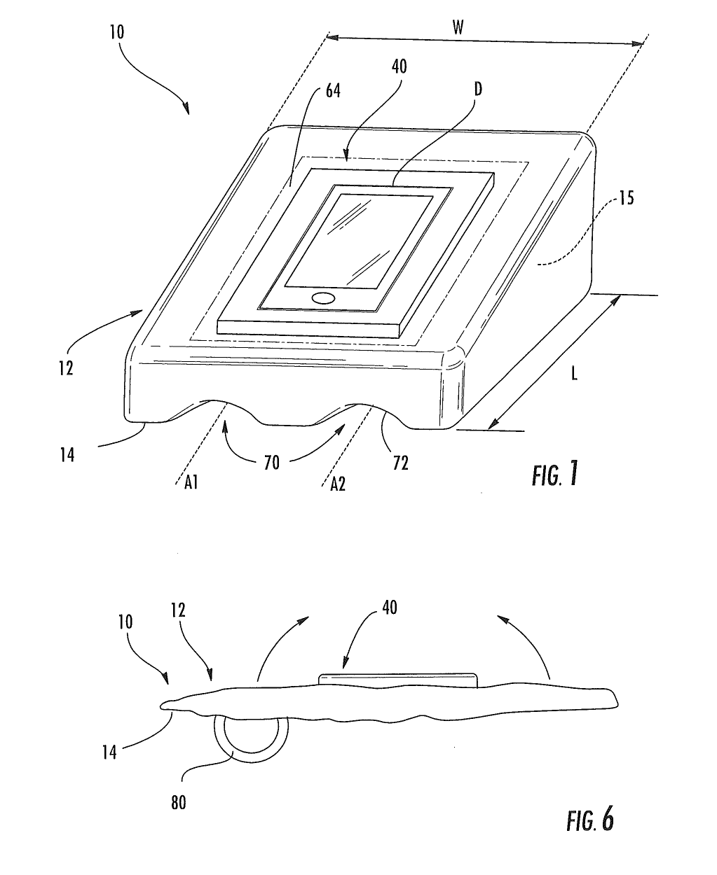

A protective case 10 for holding and protecting a portable electronic device is shown in FIGS. 1-3 and 6-8. The case 10 includes an inflatable base 12 and a pocket, pouch or sleeve 40.

The base 12 includes an outer cover or casing 14 that is impermeable or substantially impermeable to the passage of air. The cover 14 may be a durable, flexible and/or pliable film or sheet-like material, such as those commonly used in the construction of blow-up beach cushions or rafts. The cover 14 may be formed of a synthetic material (e.g., vinyl) or a woven fabric (e.g., canvas) or other suitable material. According to some embodiments, the cover 14 has a thickness of between about 0.25 mm and 25 mm.

In some embodiments, the cover 14 is a flexible, resilient, sheet-like material and forms an inflatable bladder. In some embodiments, one or more layers 14a are provided on an inner surface of the cover 14 (e.g., attached to the inner surface of the cover 14, see FIG. 7). For example, a layer of polyurethane foam or the like may be provided, similar to the construction of inflatable mattresses.

The cover 14 encloses an air cavity or chamber 15 (FIGS. 1 and 7) that is selectively filled with and discharged of air to inflate and deflate the base 12 using a valve assembly 16 (FIG. 3). The valve assembly 16 extends through the cover 14 and is configured to seal air in the chamber 15. Assorted types of known inflation valves may be utilized. In the illustrated embodiment, the valve assembly 16 includes a spout 18, similar to those found on beach balls or other inflatable pool products. A user may pull the spout 18 outwardly away from an outer surface of the cover 14 and then force air through the spout to inflate the base 12 (e.g., the user may simultaneously squeeze the spout 18 while exhaling into the spout 18). Once inflated, the user may push the spout 18 inwardly toward the cover 14 and/or arrange a cap over the spout 18 to seal the valve assembly 16.

Other valve assemblies that allow for inflation and sealing of the chamber 15 are contemplated. In some embodiments, the valve assembly 16 is configured to engage a pump, such as a manual pump or an electric pump.

The base 12 is shown in an inflated position or state in FIGS. 1-3. In the inflated state, the base 12 includes an upper surface 20, a lower surface 22, a front surface 24, a rear surface 26 and opposed side surfaces 28, 30.

The sleeve 40 is on the base upper surface 20. The sleeve is sized and configured to receive and hold a portable electronic device D (FIG. 1), such as a tablet computer, smartphone or the like. The sleeve 40 includes upper and lower connected layers 42, 44 that define a sleeve interior 46.

A closure mechanism 50 is provided on the sleeve 40. The closure mechanism 50 is movable between an open position or state and a closed/sealed position or state. In the open position, an opening 52 is exposed, and the portable electronic device D may be inserted through the opening 52 and received in the sleeve interior 46. In the closed or sealed position, the sleeve 40 is substantially waterproof or water-resistant, thereby protecting the device D from water and debris such as dirt and sand.

The closure mechanism 50 may take a variety of forms. The closure mechanism 50 may include a zipper. The closure mechanism 50 may be a Zip-Lock® type seal that has engaging ridges on inner (facing) surfaces of the sleeve upper and lower layers 42, 44. A slide mechanism 54 may be provided to close and open a zipper or to engage and disengage ridges. Other closure mechanisms, such as releasable adhesive layers, are contemplated. More than one closure mechanism may be provided to enhance the seal of the sleeve 40 in the closed position.

At least a portion of the upper layer 42 of the sleeve 40 is translucent to allow a user to view and use the portable electronic device D that is sealed within the sleeve 40. In some embodiments, the upper layer 42 is transparent. In some embodiments, the upper layer 42 is semi-transparent. The upper layer 42 is configured to allow a user to manipulate a touch sensitive display of the device D (e.g., configured such that the user may operate the touch display from outside the sleeve 40). The upper layer 42 may have sufficient flexibility to allow the user to manipulate other features of the device D, such as clickable buttons or movable dials.

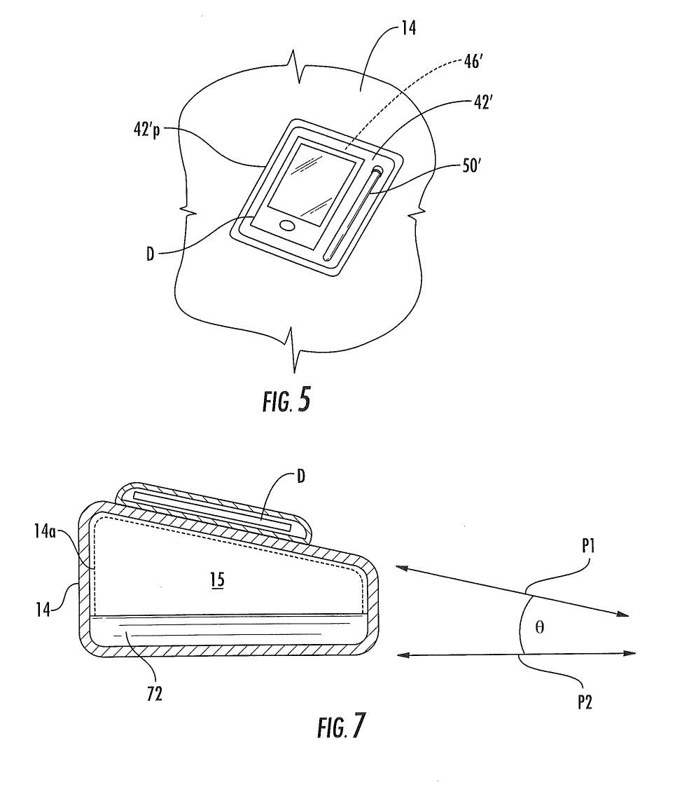

The sleeve 40 may include anti-reflective features to enhance visibility and reduce glare in sunlight. The upper layer 42 may be anti-reflective. As shown in FIG. 4A, an anti-reflective coating or film layer 60 may be provided on the upper layer 42 of the sleeve 40, for example on one or both of an inner and an outer surface of the upper layer 42.

In some embodiments, the sleeve lower layer 44 is attached to the base upper surface 20. The sleeve 40 may be attached to the base 12 in a variety of ways. For example, the sleeve 40 may be adhered to the cover 14, may be stitched to the cover 14 and so forth. In some embodiments, a plate 64 is provided on the base upper surface 20, and the sleeve 40 is attached to the plate 64. The plate 64 may have greater rigidity than the inflated base 12 to provide stability for the electronic device during use.

Other configurations for the pocket or sleeve are contemplated. As shown in FIG. 5, the sleeve may include a single layer 42′ that is adhered or otherwise attached to the cover 14 at a peripheral region 42′p of the layer 42′. A central region of the layer 42′ is not attached to the cover 14, thereby forming a pocket or cavity 46′ between the cover 14 and the layer 42′, with the pocket or cavity 46′ configured to receive and hold an electronic device. A closure mechanism 50′ may be provided on the layer 42′. The closure mechanism 50′ may be opened and closed, for example using a slide mechanism as described above with reference to the closure mechanism 50. The layer 42′ may be anti-reflective or have an anti-reflective coating or layer applied thereto.

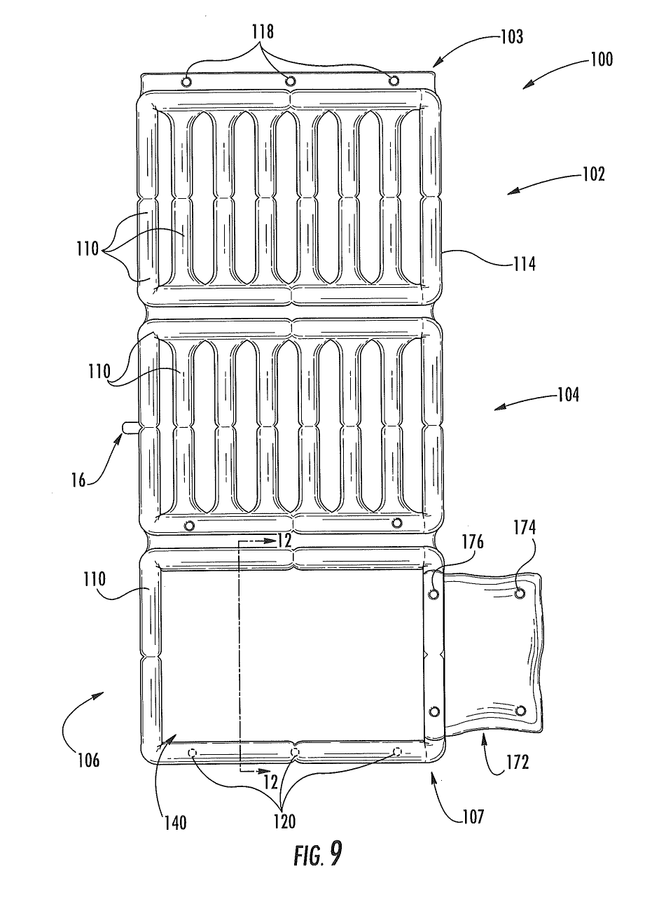

As shown in FIGS. 1, 3, 7 and 8, the base bottom surface 22 includes two generally semi-cylindrical wall portions 72 defining two respective spaced-apart contoured (concave) elongated channels or portions 70. The channels 70 extend along lengthwise axes A1, A2. As shown in FIG. 8, the channels 70 are configured to ergonomically engage with, receive and/or hold the legs 90 of a user when he or she is sitting or lying in a chair or raft, for example. According to some embodiments, the channels 70 are parallel or substantially parallel.

The length L of the base 12 may be between about 10 and 16 inches and, in some embodiments, is between about 12 and 14 inches. A width W of the base 12 may be between about 10 and 16 inches and, in some embodiments, is between about 12 and 14 inches. A height H1 of the front surface 24 of the base 12 may be between about 1 and 5 inches, between about 1 and 4 inches, and between about 1.5 and 2.5 inches in various embodiments. A height H2 of the rear surface 24 of the base 12 may be between about 4 and 10 inches, and, in some embodiments, is between about 6 and 8 inches.

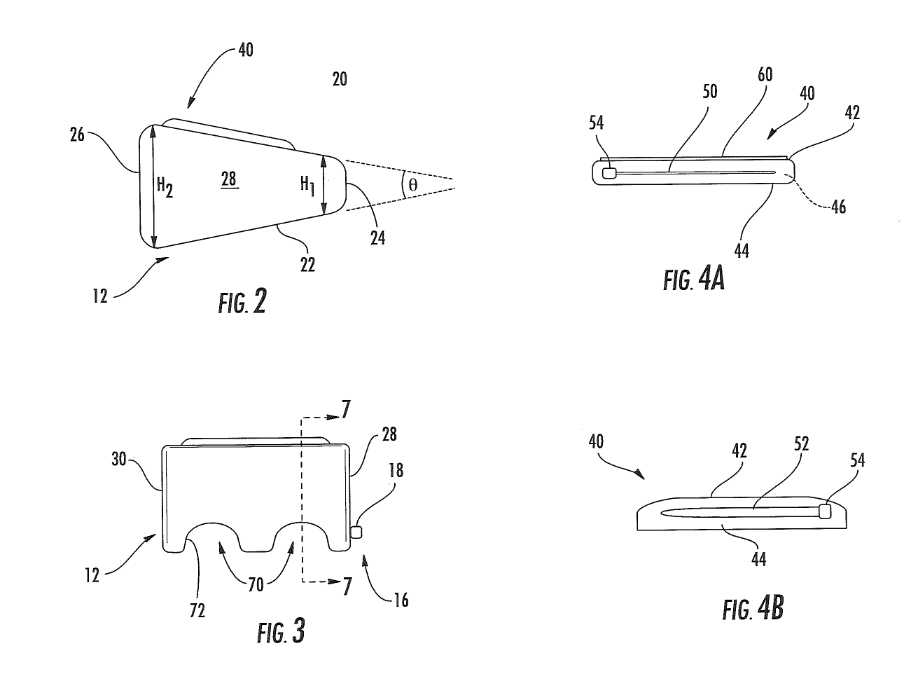

Referring to FIGS. 2 and 7, the base 12 has a wedged shaped profile when viewed from the side. The upper surface 20 is at a tilt angle θ with respect to lower surface 22, thereby tilting the electronic device D toward the user when the channels 70 are engaged with the user's legs that are extended horizontally, i.e., not inclined (or when the lower surface 22 is flat on the ground or floating in the water). The tilt angle θ may be between about 10 and 60 degrees, between about 20 and 50 degrees, and between about 30 and 45 degrees in various embodiments. As shown in FIG. 7, the base upper surface 20 may define a first plane P1 and the base lower surface 22 may define a second plane P2, with the tilt angle θ being between the planes P1, P2.

When inflated, the base 12 may have sufficient buoyancy to float on water when an electronic device is held in the sleeve 40. For example, the base 12 may have sufficient buoyancy to support more than five pounds or more than 10 pounds, which is more than enough to support even the largest of tablet computers. Thus, the base 12 may float in the pool while the user is standing in the pool and using the electronic device sealed in the sleeve 40.

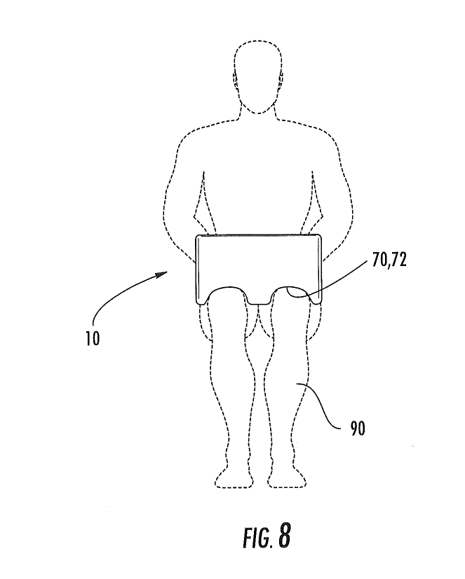

The base 12 may be deflated using the valve assembly 16 described above. For example, the user may open the valve and then apply pressure to the base cover 14 to collapse the base 12. The protective case 10 is shown in the collapsed or deflated position/state in FIG. 6. The case 10 may be further collapsed and/or folded from this position. The sleeve 40 may be formed of a flexible material to allow for the carrying case 10 to be further bunched or folded to a small volume as indicated by the arrows in FIG. 6. The case 10 has enhanced portability with the base 12 deflated. A handle 80 may be attached to or integrated with the base cover 14 to facilitate carrying the case 10.

A protective case 100 for holding and protecting a portable electronic device according to some other embodiments is shown in FIGS. 9-11. The case 100 includes first, second and third inflatable panels 102, 104, 106 and a pocket, pouch or sleeve 140 in the third panel 106. The first panel 102 is connected to the second panel 104 at respective transverse ends thereof and the second panel 104 is connected to the third panel at respective transverse ends thereof

The panels 102, 104, 106 include inflatable channels or pockets 110. As illustrated, an inflatable pocket 110 surrounds the sleeve 140 in the third panel 106. At least one valve assembly 16 is provided to inflate and deflate the inflatable pockets 110. The valve assembly 16 can have the same features and functionality as described above in connection with the case 10. The valve assembly 16 may be provided on second panel 104 as shown; alternatively, the valve assembly 16 may be provided elsewhere as long as the valve assembly 16 is in fluid communication with the inflatable pockets 110.

The case 100 and the inflatable pockets 110 have an outer cover or casing 114. The cover 114 may be formed in the same way and using the same materials as the cover 14 described above in connection with the case 10.

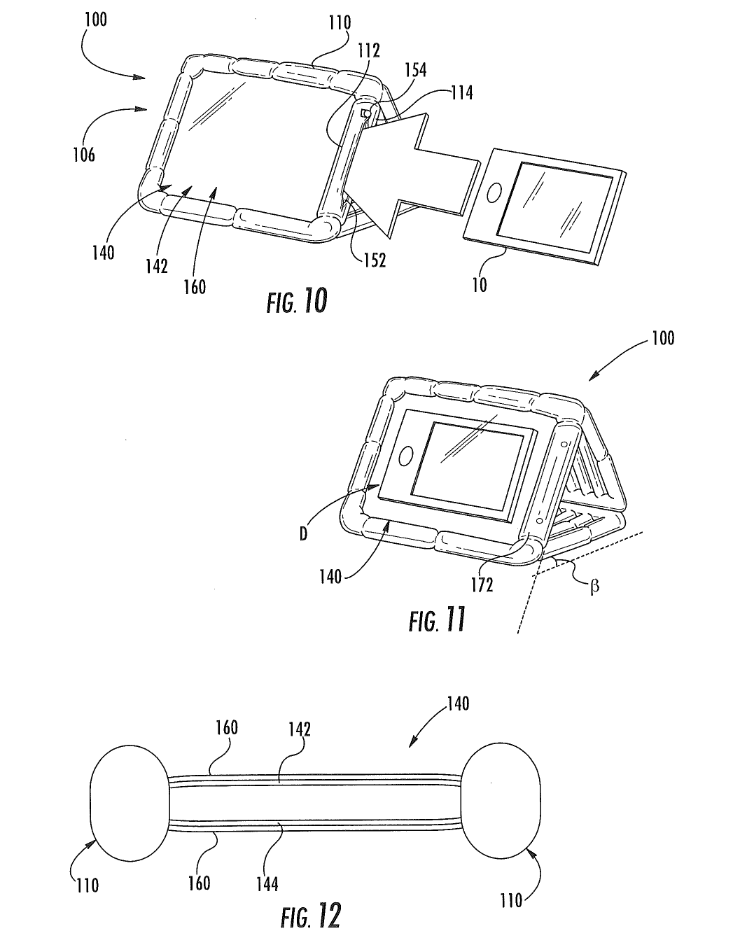

The case 100 is configured to be folded and locked in the folded position such that the case 100 has a generally triangular profile (see FIGS. 10 and 11). As shown in FIG. 9, the first panel 102 may include one or more locking mechanisms 118 at a transverse end 103 thereof and the third panel 106 may also include one or more locking mechanisms 120 at a transverse end 107 thereof. The locking mechanisms 118, 120 are configured to engage one another to lock or secure the case 100 in the folded configuration shown in FIGS. 10 and 11. In some embodiments, the locking mechanisms 118, 120 are snaps or snap mechanisms. However, it will be understood by those skilled in the art that any suitable locking mechanism may be employed (e.g., hook and loop fasteners such as Velcro®, engaging ridge mechanisms such as Ziplock®, and so forth).

Referring to FIG. 10, the sleeve 140 is sized and configured to receive and hold a portable electronic device D, such as a tablet computer, smartphone or the like. The sleeve 140 includes a first layer 142 on a first side of the third panel 106. In some embodiments, the first layer 142 is transparent. In some embodiments, the first layer 142 is semi-transparent. The first layer 142 is configured to allow a user to manipulate a touch sensitive display of the device D (e.g., configured such that the user may operate the touch display from outside the sleeve 140). The first layer 142 may have sufficient flexibility to allow the user to manipulate other features of the device D, such as clickable buttons or movable dials.

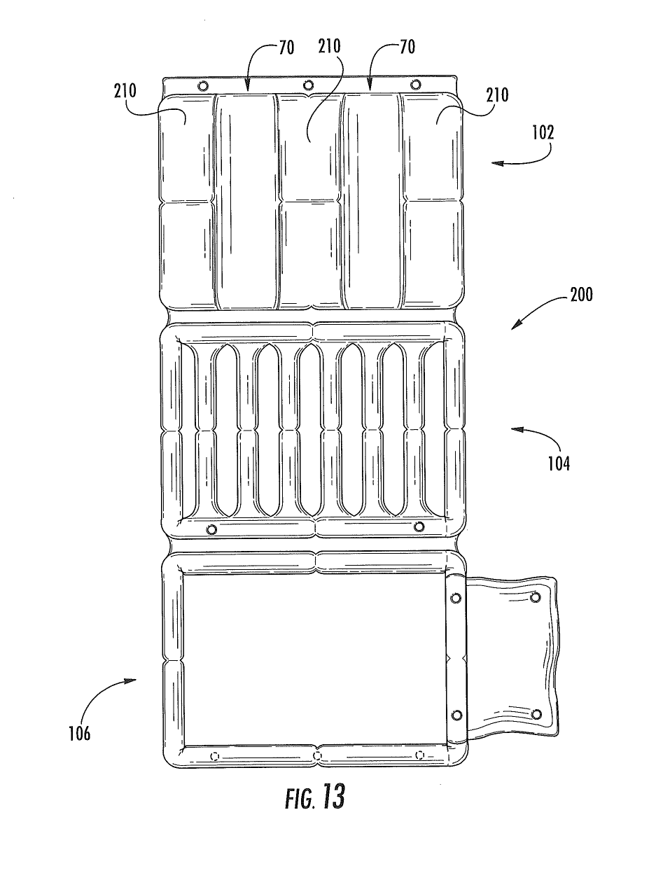

The sleeve 140 may include anti-reflective features to enhance visibility and reduce glare in sunlight. The first layer 142 may be anti-reflective. As shown in FIGS. 10 and 12, an anti-reflective coating or film layer 160 may be provided on the first layer 142 of the sleeve 140, for example on one or both of an inner and an outer surface of the first layer 142.

The sleeve 140 may be double-sided so that the case 100 can be folded in either direction while maintaining the same functionality. Referring to FIG. 12, the sleeve 140 may include a second layer 144 on a second side of the third panel 106 that is opposite the first side of the third panel 106. The second layer 144 may be same or substantially the same as the first layer 142. The second layer may be anti-reflective and/or an anti-reflective coating or film layer 160 may be provided on the second layer 144.

The sleeve 140 may be polymeric. The sleeve 140 and the case 100 (or the inflatable pocket 110) may be joined by plastic welding (e.g., heat fusion, heat welding, etc.). The sleeve 140 and the case 100 may be joined by radiofrequency heat sealing or welding (sometimes referred to as dielectric sealing or welding). Other ways of joining the sleeve 140 and the third panel 106 of the case will be understood by those skilled in the art.

As shown in FIG. 10, a slit or opening 152 is provided in the inflatable pocket 110. This portion of the inflatable pocket 110 includes a first or upper inflatable pocket portion 112 and a second inflatable pocket portion 114. The opening 152 is between the first and second portions 112, 114. The device D is received in the sleeve 140 through the opening 152. When inflated, the first and second inflatable portions 112, 114 tend to compress one another to provide at least some level of dust and/or water-resistance for the device D that has been received in the sleeve 140.

In some embodiments, a closure mechanism 150 is provided to close the opening 152 after the device D has been inserted in the sleeve 140. The closure mechanism 150 can have the same features and functionality as described above in connection with the closure mechanism 50 of the case 10. The closure mechanism 150 may be used to provide an even greater level of dust and/or water-resistance for the device D that has been received in the sleeve 140.

As shown in FIG. 9, a flap 172 may be connected to the third panel 106 of the case 100. The flap 172 includes locking mechanisms 174. The locking mechanisms 174 are configured to engage locking mechanisms 176 on the third panel 106 or the inflatable pocket 110 to secure the device D in the sleeve 140 and/or to provide additional dust and/or water-resistance by covering the sleeve opening 152. In some embodiments, the locking mechanisms 174, 176 are snaps or snap mechanisms. However, it will be understood by those skilled in the art that any suitable locking mechanism may be employed (e.g., hook and loop fasteners such as Velcro®, engaging ridge mechanisms such as Ziplock®, and so forth).

Turning to FIG. 11, the device D is shown in the sleeve 140 and the flap 172 is shown in the closed or locked position. As noted above, the case 100 assumes a generally triangular profile when folded. This configuration provides a tilt angle β. The tilt angle β may be between about 30 and 80 degrees, between about 30 and 70 degrees, and between about 30 and 60 degrees in various embodiments.

When inflated, the base 100 may have sufficient buoyancy to float on water when an electronic device is held in the sleeve 140. For example, the base 100 may have sufficient buoyancy to support more than five pounds or more than 10 pounds, which is more than enough to support even the largest of tablet computers. Thus, the base 100 may float in the pool while the user is standing in the pool and using the electronic device sealed in the sleeve 140.

The case 100 may be deflated using the valve assembly 16 described above. The case 100 may be bunched or folded to a small volume when deflated for enhanced portability.

A case 200 according to other embodiments of the invention is illustrated in FIG. 13. The case 200 is the same as the case 100 with the following differences. The first panel 102 includes three larger inflatable pockets 210. When inflated, the pockets 210 define the two spaced-apart contoured (concave) elongated channels or portions 70 described above in connection with the case 10. When the case 200 is inflated and folded, similar to the case of FIGS. 10 and 11, the channels 70 are configured to ergonomically engage with, receive and/or hold the legs of a user when he or she is sitting or lying in a chair or raft, for example, in the manner shown in FIG. 8. According to some embodiments, the channels 70 are parallel or substantially parallel.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

1. A case for use with a portable electronic device, the case comprising:
an inflatable base;
a sleeve on the base, at least a portion of the sleeve being translucent to permit a user to view the portable electronic device therethrough; and
a closure mechanism on the sleeve for sealably enclosing an electronic device in the sleeve;
wherein, when inflated, the base has opposing upper and lower surfaces with the sleeve on the upper surface, and the upper surface is at a tilt angle with respect to the lower surface.

2. The case of claim 1, wherein, when inflated, the bottom surface of the base includes two contoured surfaces extending along a length of the bottom surface, the two contoured surfaces adapted to receive legs of a user.

3. The case of claim 1, wherein the sleeve includes an upper layer that allows light to pass therethrough.

4. The case of claim 3, wherein the upper layer of the sleeve is formed of an anti-reflective material.

5. The case of claim 3, further comprising an anti-reflective coating or layer applied to the upper layer of the sleeve.

6. The case of claim 1, further comprising a valve on the base for selectively inflating and deflating the base.

7. The case of claim 1, wherein, when inflated, the base has sufficient buoyancy to float on water when an electronic device up to five pounds is sealably enclosed in the sleeve.

8. A case for use with a portable electronic device, the case comprising:
an inflatable member; and
a sleeve on the inflatable member, wherein the sleeve has an opening to receive the portable device in the sleeve, and wherein the sleeve has a translucent anti-reflective upper surface to permit a user to view the portable electronic device therethrough; and
a valve assembly for selectively inflating and deflating the inflatable member;
wherein, when inflated, the inflatable member has sufficient buoyancy to float on water when an electronic device at least about five pounds is sealably enclosed in the sleeve.

9. The case of claim 8, wherein the inflatable member comprises first, second and third inflatable panels with the second inflatable panel disposed between the first and third inflatable panels.

10. The case of claim 9, wherein the case is foldable to a folded position in which a transverse end of the first panel that is spaced apart from the second panel is connected to a transverse end of the third panel that is spaced apart from the second panel.

11. The case of claim 10, wherein the transverse end of the first panel and/or the transverse end of the third panel includes a locking mechanism configured to secure the case in the folded position.

12. The case of claim 10, wherein the case has a generally triangular profile in the folded position.

13. The case of claim 10, wherein the third panel includes the sleeve, the third panel further including an inflatable pocket surrounding the sleeve.

14. The case of claim 13, wherein a side of the inflatable pocket includes first and second inflatable portions stacked on one another with the sleeve opening defined between the first and second inflatable portions, the opening substantially closed when the first and second inflatable portions are inflated.

15. The case of claim 14, wherein the sleeve comprises first and second translucent anti-reflective opposing surfaces to permit a user to view the portable electronic device through either the first or the second translucent anti-reflective surface.

16. The case of claim 14, further comprising a flap having a first end connected to the side of the inflatable pocket adjacent the opening and a second end that extends away from the third panel, wherein the side of the inflatable pocket and/or the second end of the flap comprises a locking mechanism configured to secure the second end of the flap to the side of the inflatable pocket such that the flap covers the sleeve opening.

17. The case of claim 14, wherein the first panel comprises a plurality of inflatable pockets defining two spaced-apart contoured channels extending along a length of the first panel, each channel configured to receive a respective leg of a user when the case is in the folded position.

18. A case for use with a portable electronic device, the case comprising:
first, second and third longitudinally connected inflatable panels, the second panel disposed between the first and third panels, the first panel having a transverse end that is spaced apart from the second panel, the third panel having a transverse end that is spaced apart from the second panel; and
a sleeve on the third inflatable panel, wherein the sleeve has an opening to receive the portable device in the sleeve, and wherein the sleeve has a translucent anti-reflective upper surface to permit a user to view the portable electronic device therethrough;
wherein the case is foldable to a folded position in which the transverse end of the first panel is connected to the transverse end of the third panel;
wherein at least one of the transverse end of the first panel and the transverse end of the third panel comprises a locking mechanism to secure the case in the folded position.

19. The case of claim 18, wherein:
the third panel further comprises an inflatable pocket surrounding the sleeve wherein a side of the inflatable pocket includes first and second inflatable portions stacked on one another with the sleeve opening defined between the first and second inflatable portions, the opening substantially closed when the first and second inflatable portions are inflated;
the sleeve comprises first and second translucent anti-reflective opposing surfaces to permit a user to view the portable electronic device through either the first or the second translucent anti-reflective surface; and
the case further comprises a flap having a first end connected to the side of the inflatable pocket adjacent the sleeve opening and a second end that extends away from the third panel, wherein the side of the inflatable pocket and/or the second end of the flap comprises a locking mechanism configured to secure the second end of the flap to the side of the inflatable pocket such that the flap covers the sleeve opening.

20. The case of claim 18, wherein the first panel comprises three inflatable pockets defining two spaced-apart contoured channels extending along a length of the first panel, each channel configured to receive a respective leg of a user when the case is in the folded position.
